(19) United States
(12) Patent Application Publication
(10) Pub. No.: US 2006/0146353 A1
(43) Pub. Date: Jul. 6, 2006

(54) Strategies for rendering job information using a multi-personality driver device

(75) Inventors: Feng Yue, Sammamish, WA (US); Harvinder P. Singh, Redmond, WA (US); Daniel F. Emerson, Redmond, WA (US); Craig I. McLuckie, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/026,351

(22) Filed: Dec. 30, 2004

(51) Int. Cl. G06F 15/00

(52) U.S. Cl. 358/1.13; 358/1.1

(57) ABSTRACT

Strategies are described for processing job information using a multi-personality driver device. The driver device includes multiple selectable rendering modules for processing job information in the context of multiple selectable rendering paths. The driver device further contains a configuration module for selecting one of the rendering paths for a particular rendering scenario. The configuration module also exposes characteristics of various rendering paths, and facilitates the configuration of the rendering paths. The driver device uses a single rendering queue to allow applications to interact with all of the available rendering paths supported by the driver device.

### TECHNICAL FIELD

This subject matter relates to strategies for rendering job information. In a more particular implementation, this subject matter relates to strategies for rendering job information in an application environment that supports multiple rendering paths.

### BACKGROUND

In a typical rendering operation, an application, operating within a particular application framework, provides job information to a target device. Exemplary target devices can include printer devices, display devices, facsimile machines, any kind of network recipients, and so forth. The application framework includes graphics functionality for expressing the job information in a prescribed graphics language. The application then forwards the job information to a rendering subsystem via a rendering queue. The rendering subsystem may store the job information in a spool storage. The rendering subsystem then retrieves the job information from the spool storage, processes the job information, and then forwards the processed job information to the target device.

More specifically, the rendering subsystem employs a driver to convert the job information from the graphics language used by the application framework to a Page Description Language (PDL) used by the target device. Common types of PDLs include PostScript, Printer Control Language (PCL), and so forth. The driver has various characteristics (e.g., features) which describe its capabilities. The rendering subsystem can expose the driver's characteristics to an application so that a user can be apprised of these characteristics. The user can select various options pertinent to the characteristics which will govern the behavior of the rendering operation using that driver.

A single user environment may accommodate the use of different application frameworks that use different graphics functionality for expressing job information. A single target device may also accept job information in different PDL formats. One way of addressing this situation is by providing a different driver to account for each permutation of application framework and PDL format. For instance, a driver D₁ can be provided to convert job information from input application format A₁ to PDL format P₁, a separate driver D₂ can be provided to convert job information from input format A₁ to PDL format P₂, and a third driver D₃ can be provided for converting job information from input format A₂ to PDL format P₁, and so on. These systems allocate a separate rendering queue to each driver. As such, multiple rendering queues (and associated drivers) may be allocated to a single target device.

The above approach has drawbacks. For instance, the above approach may force the user to choose which rendering queue (and associated driver) that he or she wishes to use when operating within a given application framework. This may not present a difficulty for sophisticated users who have technical insight into the different rendering paths supported by their systems. However, the plethora of rendering queues and associated drivers may confuse and frustrate other users, who have neither the experience to select the proper rendering queue nor the desire to gain further technical knowledge about their systems. Moreover, the management of plural rendering queues and associated drivers may prove to be unwieldy and costly to maintain.

For at least the above-identified reasons, there is an exemplary need for more satisfactory strategies for processing job information.

### SUMMARY

According to one exemplary implementation, a system is described for processing job information. The system comprises at least one application framework for preparing job information expressed in a prescribed graphics language and a rendering subsystem for processing the job information using plural selectable rendering paths. The rendering subsystem includes an integrated driver device. The driver device, in turn, comprises a rendering queue for coupling the above-mentioned at least one application framework with the rendering subsystem for all of the plural selectable rendering paths. The driver device also comprises plural selectable rendering modules for performing different respective processing operations on the job information in the context of the respective plural rendering paths. The driver device also comprises a configuration module for coordinating the processing of the job information using a selected one of the plural rendering modules in the context of a selected one of the plural rendering paths, to yield processed job information. The processed job information is forwarded by the driver device to a target device.

Additional exemplary implementations are described in the following.

### BRIEF DESCRIPTION OF THE DRAWINGS

FIG. 1 shows an exemplary system for processing job information using a multi-personality driver device.

FIG. 2 illustrates an exemplary configuration module used in the multi-personality driver device of FIG. 1.

FIG. 3 shows an implementation of the system of FIG. 1 which uses two exemplary rendering paths.

FIG. 4 shows an exemplary variation of the system of FIG. 1 in which the multi-personality driver device supports at least two rendering paths associated with different target device formats.

FIG. 5 shows an exemplary procedure that sets forth a manner of operation of the system of FIG. 1.

FIG. 6 shows an exemplary computer environment for implementing aspects of the system shown in FIG. 1.

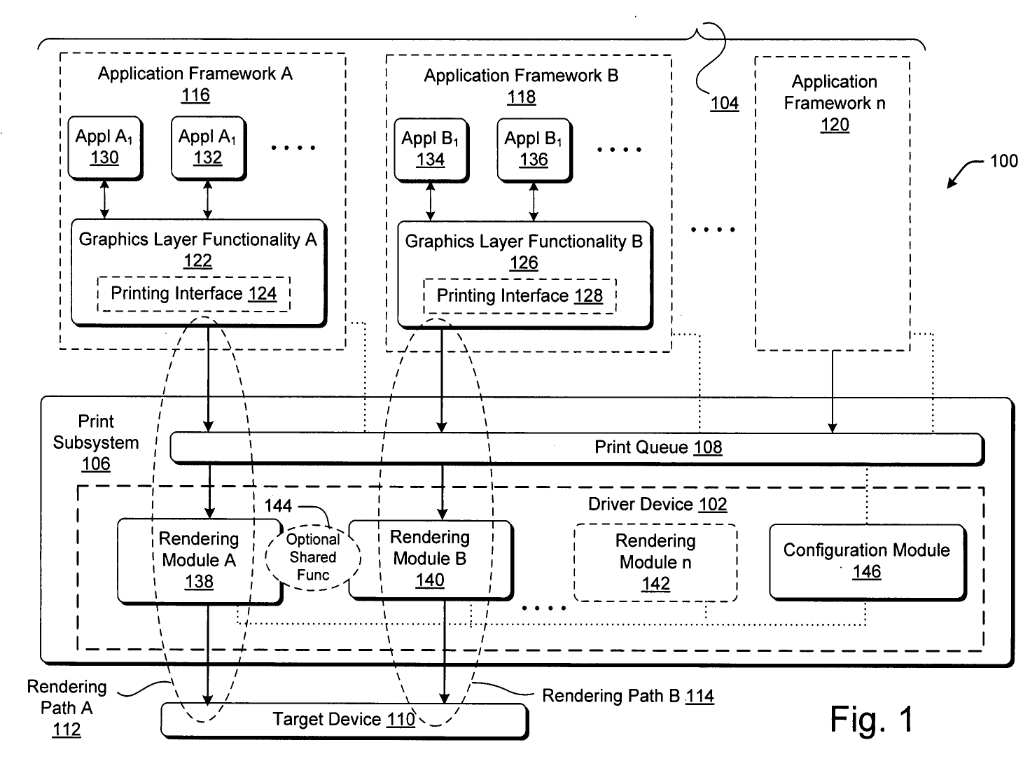

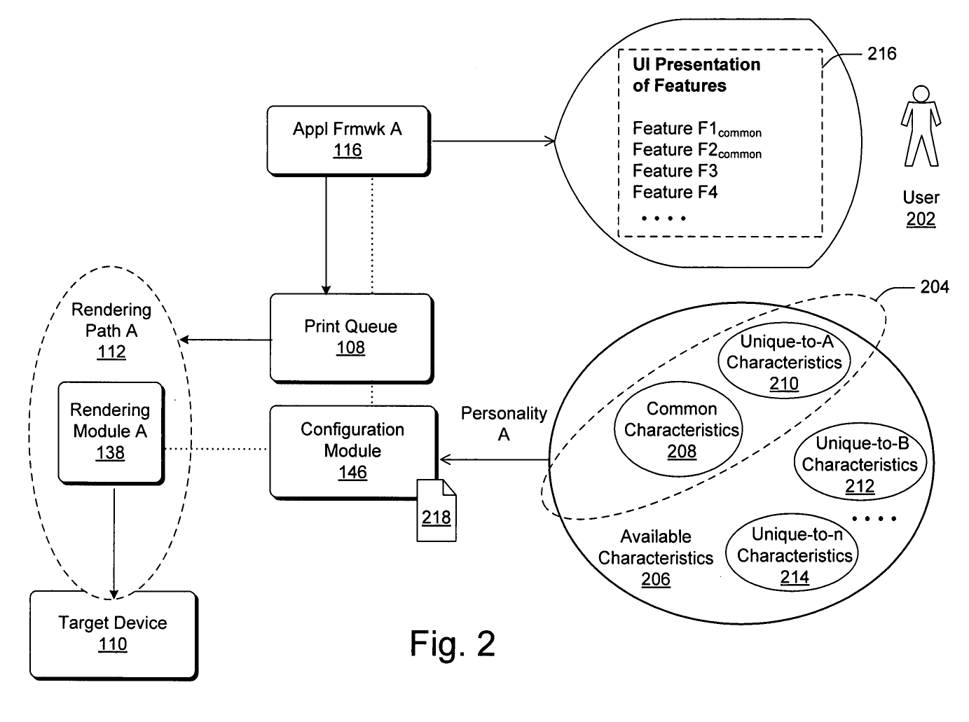

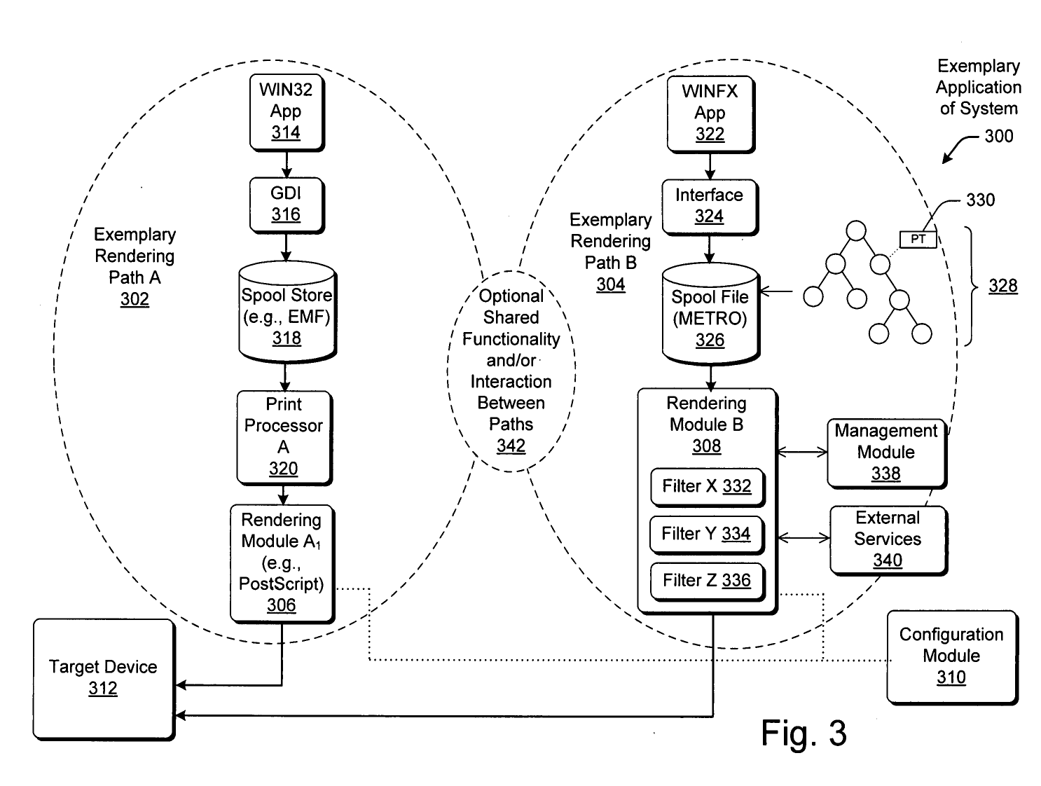

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

The following description sets forth strategies for processing job information using a single driver that supports multiple rendering paths from applications to a single target device. The different rendering paths may allow different application frameworks (which may use different graphics functionality, such as different graphics engines) to access the same target device. The different rendering paths may also allow an application to interact with the target device using different Page Description Language (PDL) formats that are supported by the target device, as well as access other capabilities of the paths (such as packaging, archiving, etc.). The various rendering paths are accessible to applications via a single rendering queue (e.g., a single print queue).

In one exemplary implementation, the strategies include mechanisms for automatically selecting an appropriate rendering path depending on one or more factors. In another exemplary implementation, the strategies may permit a user, such as a system administrator (e.g., computer administrator or network administrator), to manually select the rendering path.

To perform in the manner described above, the driver device includes a plurality of rendering modules, which, in part, implement the separate rendering paths. The driver device also includes a configuration module which coordinates the selection of an appropriate rendering module, the exposure of the module's selected rendering characteristics to an application, and the setting of rendering options that will govern the operation of the selected rendering module.

The strategies described herein confer a number of benefits. According to one benefit, the use of a single rendering queue (and associated single device driver) may reduce a user's confusion, reduce system management cost, etc., e.g., compared to the alternative case of providing multiple rendering queues (and associated multiple driver devices) for a single target device.

Additional features and attendant benefits of the strategies will be set forth in this description.

As to terminology, the term “job” used herein refers to a task in which one or more actions are performed to process job information. For instance, a print job may entail printing job information that defines one or more documents. More generally, reference to “processing” job information can refer to any kind of rendering of such job information, such as printing or displaying such job information. Alternatively, processing can refer to distributing the job information to a target destination (with or without modifying it), archiving the job information, or some other form of processing. The term “job information” refers to any kind of information used to specify the nature of the job, such as the actual graphics content to be rendered, and/or information that defines how the job is to be rendered, and so on.

The term “document” as used herein refers to any unit of any kind of graphical information. For example, a document may pertain to information created by a text editing application, a spreadsheet processing program, a drawing program, and so on. Each document can have multiple associated parts, each of which can itself be considered a component document in its own right. For example, in one non-limiting case, a document may consists of: (1) graphical information; (2) a set of resources for “use” by the graphical information (e.g., fonts, images, etc); and (3) a structure that binds together the graphical information and resources, and so forth (for example, a document may include a set of pages, where fonts can be associated with individual pages, etc.)

This disclosure includes the following sections. Section A presents exemplary systems for processing job information using a multi-personality driver device. Section B presents a procedure which explains the operation of the systems of Section A. Section C describes an exemplary computer environment for implementing aspects of the systems of Section A.

A. Exemplary System

Generally, any of the functions described with reference to the figures can be implemented using software, hardware (e.g., fixed logic circuitry), manual processing, or a combination of these implementations. The term “logic, “module” or “functionality” as used herein generally represents software, hardware, or a combination of software and hardware. For instance, in the case of a software implementation, the term “logic,” “module,” or “functionality” represents program code that performs specified tasks when executed on a processing device or devices (e.g., CPU or CPUs). The program code can be stored in one or more computer readable memory devices. More generally, the illustrated separation of logic, modules and functionality into distinct units may reflect an actual physical grouping and allocation of such software and/or hardware, or can correspond to a conceptual allocation of different tasks performed by a single software program and/or hardware unit. The illustrated logic, modules and functionality can be located at a single site (e.g., as implemented by a processing device), or can be distributed over plural locations.

A.1. Overview of the System: Separate Application Frameworks Accessing a Single Target Device via a Single Rendering Queue and Associated Single Driver device

FIG. 1 shows an exemplary system 100 that can be used to implement a multi-personality driver device 102. By way of overview, the system 100 includes applications that operate within the context of multiple different kinds of application frameworks 104. The applications forward job information to a rendering subsystem (e.g., a print subsystem 106) via a single rendering queue (e.g., a print queue 108) of the rendering subsystem. The print subsystem 106 uses the driver device 102 to forward processed job information to a target device 110. Note that, to facilitate discussion, reference will henceforth be made to an implementation where rendering takes the form of printing job information (which thus explains the use of the terms “print subsystem” and “print queue”); however, the principles described herein can be applied to any system that renders job information using, more generally stated, a “rendering subsystem” and “rendering queue.”

As shown in FIG. 1, the driver device 102 supports plural rendering paths (112, 114, . . . ) for use in communicating with the single target device 110. The term “rendering path” refers to a grouping of processing functionality which routes job information from a source application framework to the destination target device 110. There are at least two degrees of freedom which determine the rendering paths that may be appropriate for inclusion in a single driver device 102. A first degree of freedom may account for different application frameworks 104 that can access the target device 110. A second degree of freedom may account for the fact the target device 110 itself may accept job information in different Page Description Language (PDL) formats. A separate rendering path can be allocated to each of these different permutations, all accessed through the single print queue 108 and an associated single driver device 102.

Nevertheless, so as to more clearly set forth the features of the driver device 102, preliminary discussion will be confined to the case where the driver device 102 allocates different rendering paths (112, 114, . . . ) for coupling different application frameworks 104 to the target device 110. Subsection A.4 (below) will introduce the further variation in which the driver device 102 also devotes plural rendering paths that allow one or more application frameworks to access the target device 110 using different PDL formats supported by the target device 110.

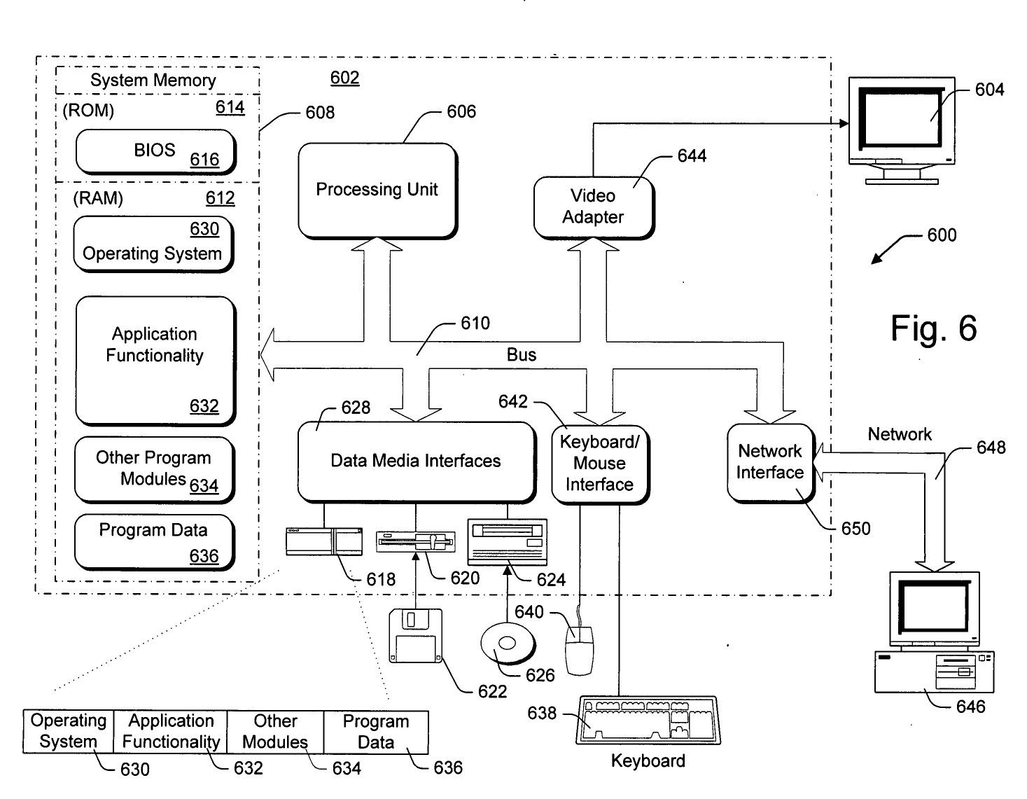

To begin with, the separate components shown in FIG. 1 can be implemented by any combination of software and/or hardware. Moreover, the different components can be implemented by any combination of stand-alone units, or as different modules within a single unit or units. For example, in one exemplary and non-limiting case, a computer device can implement aspects of the system 100 shown in FIG. 1, including one or more of the application frameworks 104 and the associated print subsystem 106. In another case, a networked coupling of different computer devices can implement different aspects of the system 100 shown in FIG. 1. FIG. 6, to be described in turn, describes exemplary characteristics of a computer environment that can be used to implement any aspect of the system 100 shown in FIG. 1.

Turning to the above-identified individual components in FIG. 1, the application frameworks 104 can include a plurality of different types of application frameworks (116, 118, . . . 120). As this term is used herein, an application framework refers to any technology platform for processing and presenting information using a prescribed programming paradigm. These different application frameworks (116, 118, . . . 120) are distinguished, in part, by their differing uses of graphics functionality. Namely, application framework A 116 uses graphics functionality A 122 to express job information, which it forwards to the print subsystem 106 via printing interface 124. Application framework B 118 uses graphics functionality B 126 to express job information, which it forwards to the print subsystem 106 via printing interface 128, and so forth. A suite of different applications (130, 132 . . . ) interact with the print subsystem 106 using application framework A 116. Another suite of applications (134, 136 . . . ) interact with the print subsystem 106 using application framework B 118. Such applications (130, 132, . . . 134, 136 . . . ) may represent any software and/or hardware modules for performing any kind of prescribed tasks. Exemplary applications may include word processing programs, spreadsheet programs, web interface programs, and so forth.

By way of non-limiting example, in one illustrative environment, application framework 116 can correspond to applications which express job information using Microsoft Corporation's Win32® Graphics Device Interface (GDI) application framework, provided by Microsoft Corporation of Redmond, Wash. Application framework B 118 can correspond to applications which express job information using Microsoft Corporation's WinFX framework, in which an application can provide job information expressed in a so-called METRO format, e.g., as fully described in co-pending and commonly assigned U.S. patent application Ser. No. 10/836,327, entitled “Document Mark Up Methods and Systems,” filed on May 1, 2004, which is incorporated herein by reference in its entirety. (Subsequent mention of the “METRO” format will serve as a shorthand reference for the formats described in the '327 application, or any like format). To emphasize, however, the system 100 can be applied to other types of systems that use other kinds of graphics paradigms for formatting job information. For example, another application framework can correspond to products produced by Adobe Systems Incorporated, of San Jose, Calif., and so forth.

The print queue 108 of the print subsystem 106 may represent any software and/or hardware functionality for allowing the application frameworks 104 to interact with the print subsystem, and can be implemented in different ways. In one case, the print queue 108 can represent functionality that implements a collection of tasks using a suitably configured application programming interface (API). The print queue 108 generally provides a protocol through which an application can add jobs to the print system 106, retrieve job status, delete jobs, and so forth. The print queue 108 also provides a portal through which any application can interact with the configuration functionality of the print subsystem 106, e.g., in order to query the capabilities of the driver device 102, and to set the operating parameters that will govern the driver device 102's operation.

The print subsystem 106 itself can include a plurality of components designed to transform the job information from the format provided by the application frameworks 104 to the PDL format required by the particular target device 110. As will be described more fully in connection with FIG. 3, such components can include one or more spool stores for storing the job information, one or more print processors for processing the job information, the driver device 102 itself, and so forth. Because the focus of this discussion pertains to the driver device 102, the print subsystem 106 in FIG. 1 shows only this component in detail.

The driver device 102 includes plural rendering modules (138, 140, . . . 142). The rendering modules (138, 140, . . . 142) can perform a variety of operations on the job information. One purpose of these modules (138, 140, . . . 142) is to convert the job information into whatever format is required by the target device 110. These modules (138, 140, . . . 142) therefore can perform a format translation operation, from an input format associated with the application frameworks 104 to an output format associated with the target device 110. Of course, if the target device 110 can receive and interpret the format provided by an application framework (as is potentially the case, for instance, in the exemplary WinFX programming environment described in the context of FIG. 3), then the associated rendering module may not have to perform such translation, or may perform only a partial translation of format. As another caveat, FIG. 1 illustrates the different rendering modules (138, 140, . . . 142) as distinct and self-contained modules to facilitate discussion. However, one or more rendering modules (138, 140, . . . 142) can share common functionality, as represented by the overlapping oval 144.

This subsection (A.1) focuses on the case in which the driver device 102 is used to couple different application frameworks 104 to the single target device 110 (ignoring, for the moment, that the target device 110 itself may accept job information in different PDL formats, which might warrant the use of separate rendering modules). In this context, exemplary rendering path 112 couples an application within application framework A 116 to the target device 110 using rendering module A 138. Exemplary rendering path 114 couples an application within application framework B 118 to the target device 110 using rendering module B 140, and so on. For instance, in the exemplary and non-limiting example discussed above, rendering module A 138 may be configured to convert job information produced using the Win32® GDI paradigm to whatever PDL is required by the target device 110 (e.g., PostScript, PCL, etc.). Rendering module B 140 may be configured to convert job information produced using the METRO paradigm to whatever PDL is required by the target device 110 (e.g., PostScript, PCL, some variation of the METRO format, etc.).

Each of these different rendering paths (112, 114 . . . ) has different characteristics. The characteristics are determined, in part, by the capabilities associated with the target device 100, as well as the features of the rendering modules (138, 140 . . . ) which are designed to interact with the target device 110. In this sense, each of the different rendering paths (112, 114 . . . ) and associated rendering modules (138, 140, . . . 142) has a different “personality.” The driver device 102, as a whole, may therefore be characterized in the manner stated above as a “multi-personality” driver device. Again note that, although this driver device 102 has multiple personalities, it nevertheless interacts with the different application frameworks 104 via the single print queue 108.

The driver device 102 relies on a configuration module 146 to govern its functions. The configuration module 146 performs several tasks. According to one task, the configuration module 146 automatically determines what rendering module (138, 140, . . . 142) should be invoked to handle a particular job, and then invokes that rendering module (which, in turn, will invoke a particular rendering path). It can make this decision based on a combination of different factors, such as the nature of the application framework 104 that is being used to format the job information, the nature of the PDL format that is being used by the target device 110, and so forth. In one implementation, the configuration module 146 performs this task automatically so that the user will not have to manually select a rendering path (and associated print queue). In this scenario, the user may not even be aware that the driver device 102 accommodates plural rendering paths. Stated another way, the configuration module 146 permits the application frameworks 104 to adopt an agnostic approach with respect to the driver device 102's utilization of multiple rendering paths. In another implementation, the configuration module 146 can alert the user to the fact that there are multiple rendering paths, and allow the user to select one of these paths (which will invoke a corresponding rendering module used by the selected path).

According to another task, the configuration module 146 exposes the characteristics of different rendering paths (and associated rendering modules) to users within the application frameworks 104. For instance, assume that a user prepares a document using a word processing program within application framework A 114. Assume that the user then invokes a print command to examine the characteristics of the rendering path 112 which routes job information from the word processing program to a selected target device 110. The configuration module 146 would come into play here by, via the single print queue 108, exposing a set of characteristics pertinent to the rendering path 112 to the user. These characteristics will generally identify the features of the rendering module A 138 which will be employed by rendering path 112 to process the job information.

The characteristics associated with one rendering path can differ from the characteristics associated with other rendering paths. Yet there may be common characteristics that are shared by multiple rendering paths, since these different paths ultimately send job information to the same target device 110. The configuration module 146 is configured to handle this situation by only exposing the characteristics that are pertinent to a particular rendering path being invoked. In the example above, for instance, the configuration module 146 would only present those characteristics which pertain to rendering path 112, not those which pertain to rendering path 114. Nevertheless, as stated, rendering path 112 may share characteristics in common with rendering path 114. In one exemplary implementation, the configuration module 146 can therefore identify those characteristics which are common to rendering path 114. Characteristics that are not earmarked as “common” can be interpreted as unique to the rendering path 112. In another exemplary case, the configuration module 146 can simply present a set of characteristics to the user that are associated with path 114 without expressly identifying which characteristics are common to all paths and which characteristics are unique to path 114.

The above-discussed “characteristics” can correspond to co-called printing features that reflect the capabilities of a selected rendering module and/or other components of its rendering path (such as a print processor). Some of the features may reflect the physical properties of the target device 110, while other of the features may refer to software aspects of the rendering module or other components of the rendering path (which may not have a direct counterpart in terms of the physical properties of the target device 110). Exemplary well-known features can include: Collate; ColorMode; Duplex; Halftone; InputBin; MediaType; Memory; Orientation; OutputBin; PageProtect; PaperSize; Resolution; Stapling, and so forth. An illustrative feature that may be categorized as “common” is Memory, since all of the rendering paths interact with the target device 110 using the same memory configuration. An illustrative feature that may be categorized as “unique” to a particular rendering path is a font-related feature, because different rendering modules may use different font resource and/or techniques. Another illustrative feature that may be categorized as unique to a particular rendering path is Watermark (which may apply, for instance, to only one rendering path).

According to another task, the configuration module 146 can also receive the selections of a user associated with the characteristics of a rendering path, which will govern the behavior of the rendering module being employed. For instance, each of the rendering features can be assigned one or more selectable states, referred to as options. The user can make various selections regarding options that apply to different features. The configuration module 146 plays a role in propagating this configuration information to the appropriate rendering module. (As used herein, the term “characteristic” is intended to broadly encompass either a feature per se, or just an component of a feature (e.g., an option)).

To summarize, one role of the configuration module 146 involves the communication of configuration information within a selected rendering path to the user. For instance, the target device 110 and associated rendering module used by the rendering path can supply information regarding their capabilities. Another role of the configuration module 146 is to propagate job-specific configuration information down through the rendering path, where it is used to govern the behavior of the rendering path. As will be described in the context of FIG. 3, different rendering paths can use different techniques for exposing path capabilities to applications, and for pushing configuration instructions down to appropriate actors in the rendering paths.

A number of variations and extensions of the above-described design are possible.

According to one feature, the above discussion set forth a scenario in which the configuration module 146 presents a set of characteristics to a user which is tailored to a particular rendering path (e.g., based on the user's investigation of the characteristics within a particular application framework). However, the configuration module 146 can provide more comprehensive presentations that display the characteristics of all of the rendering paths supported by the driver device 102. For instance, a general utility presentation may allow the user to select preferences which govern the operation of all of the rendering paths that might be invoked in different printing scenarios. Such a utility presentation may optionally demarcate characteristics which are common to all rendering paths, and those which are unique to particular rendering paths. The user's selections regarding common characteristics apply to all rendering paths (or at least plural rendering paths). The user's selections regarding path-unique characteristics apply to only certain identified rendering paths.

According to another feature, in addition to marking features as either common or unique, the configuration module 146 can allow for the marking of individual options associated with features as common or unique. For example, assume that multiple paths support a feature X, but the paths support different respective sets of options associated with feature X. For example, path p1 might support options a, b, and d, while path p2 might support options a and c, and so forth. The configuration module 146 can mark those options that are common to all paths as common (e.g., option “a”) and those that are unique to specific paths as unique. Thus, as used herein, a general reference to a common or path-specific “characteristic” might refer to either a feature as a whole or a component of a feature.

According to another feature, the above-described examples primarily set forth an implementation in which the configuration module 146 automatically selects an appropriate path based on various factors (such as the application framework being used, the PDL format being used, and so forth). In another exemplary case, the system 100 may permit a user, such as a system administrator (e.g., computer administrator or network administrator), to manually select the rendering path based on various considerations. Or the selection can be performed in a collaborative manner; for instance, the configuration module 146 can provide suggestions or analysis results to the user, and the user can make a manual selection based on this information.

According to another feature, other components in the system 100 can perform the automated or semi-automated path selection described above besides the configuration module 146 or in cooperation with the configuration module 146. Such components can include any component within an application, any component with an application framework, any component within the driver device 102, and so forth.

According to another feature, the system 100 can make a rendering path selection based on additional factors or different factors than the factors set forth above. For example, the system 100 can select a rendering path based on any one or more of the following considerations: (a) a determination of what rendering path is best suited to archive the job information or to package the job information; (b) a determination of what rendering path is best suited to compress the job information, and so forth.

According to another feature, the above-described configuration module 146 has been illustrated and described as a single self-contained unit. However, in another exemplary implementation, this configuration module 146 may represent plural distinct configuration modules (not shown) which serve plural associated rendering paths.

According to another feature, the above-described system 100 uses a single print queue 108 to interact with the driver device 102. However, in other exemplary implementations, the system 100 can include plural print queues (not shown). For instance, suppose that a driver device 102 supports n rendering paths. A first print queue could service a subset x of rending paths of the n rendering paths, a second print queue could service a subset y of rendering paths of the n rendering paths, a third print queue could service a subset z of rendering paths of the n rendering paths, and so forth. In other exemplary implementations, each rendering path in the driver device 102 can have its own allocated print queue. This would not fully address the problem mentioned in Background section, but it is still advantageous in the sense that the driver device 102 can integrate multiple rendering modules into a single package, and those rendering modules can potentially share resources, etc.

Still other variations of the system 100 are possible.

A.2. The Configuration Module

FIG. 2 provides information regarding the role of the configuration module 146, which clarifies and expands on the above discussion. Namely, FIG. 2 shows the role played by the configuration module 146 in processing job information using rendering path A 112. As discussed, rendering path A 112 includes application framework A 116, which forwards job information to rendering module 138 via print queue 108. Rendering module A 138 processes the job information and converts it to whatever PDL format is expected by the target device 110. For simplicity, it is again assumed that the target device 110 accepts job information in a single PDL format.

Assume that the scenario described above again applies, in which a user 202 desires to investigate the characteristics of rendering path A 112 (and associated rendering module 138). The configuration module 146 comes into play by culling a set 204 of characteristics that apply to rendering path A 112 from a larger body of characteristics. Namely, a complete set 206 of characteristics represents characteristics that apply to all of the rendering paths supported by the driver device 102. Within that complete set 206, a common set 208 of characteristics describe characteristics which apply to all rendering paths (or, optionally, at least plural rendering paths). Another set 210 of characteristics apply to just rendering path A 112, and are therefore unique to this rendering path. Another set 212 of characteristics apply to just rendering path B 114. Another set 214 of characteristics applies to still another rendering path. The set 204 that is appropriate to path A 112 is therefore found by aggregating the set 208 of common characteristics with the set 210 of characteristics which are unique to rendering path A 112.

The configuration module 146 can facilitate the exposure of the combined set 204 to the user 202 via any kind of user interface presentation 216. For instance, the user may invoke a particular user interface presentation within the context of a particular application (such as a word processing program), or within a general utility interface, and so forth. In any event, the user interface presentation 216 can optionally include visual indicia which earmark the characteristics as common or unique. Alternatively, as is the case in FIG. 2, the user interface presentation 216 can mark only those characteristics which are common, whereupon the user 202 can interpret the remainder of the characteristics as unique to path A 112. In still another example, the user interface presentation 216 may not discriminate between common and path-specific characteristics, or may only display such path-related information to administrative users but not “regular” users.

The configuration module 146 can implement the above-described functionality in various ways. According to one technique, the configuration module 146 can store one or more text files 218 which identify all of the different capabilities (e.g., features) supported by all of the different rendering modules (138, 140, . . . 142). The text files 218 can include any kind of tag information which identifies whether the characteristics are common, and, if unique, to which rendering path the characteristics apply. Other techniques for expressing the characteristics are possible; for instance, the configuration information can be stored in a non-text file or can be hard-coded in the configuration module 146, etc.

As stated in the previous subsection, there may be instances where a certain feature is employed in multiple different rendering paths, yet is implemented by the different rendering paths in a different manner (because, for example, different rendering paths support different options associated with this feature). In this case, the configuration module 146 can separately categorize the options as common or unique. For example, consider the illustrative case in which the general feature “watermark” is common to two paths, yet one of the paths supports only text watermarks, while the other path supports both text and image watermarks. In this case, the option “text” for this option might be marked as common, while the option “image” might be marked as path-specific

A.3. Application of the System to Exemplary Rendering Paths

FIG. 3 illustrates one exemplary implementation 300 of the driver device 102 of FIG. 1. The driver device in FIG. 3 can generally be referred to a multi-headed driver (also referred to as a multi-personality driver herein). In the illustrative case of FIG. 3, the multi-headed driver defines a “dual-headed” driver, as it supports a first rendering path 302 associated with a first application framework A and a second rendering path 304 associated with a second application framework B. The first rendering path 302 employs rendering module A 306, and the second rendering path 304 employs rendering module B 308. The driver device, in this instance, would therefore encompass a configuration module 310, the rendering module A 306, and the rendering module B 308. Both of these rendering paths (302, 304) are presented by a single print queue (not shown in FIG. 3).

Both of these rendering paths (302, 304) feed processed job information to a target device 312. The target device 312 can comprise any kind of functionality for receiving the processed job information. Exemplary target devices can include printer devices, display devices, facsimile machines, storage devices, any kind of network recipients, and so forth. The target device 312 can be local or remote with respect to the application which invokes it. Again, for the sake of simplicity, it will be assumed that each of the application frameworks do not accommodate plural rendering paths to account for plural potential PDLs that the target device 312 may accept. (However, the next subsection will address this variation.)

The remaining discussion will describe the composition and operation of the rendering paths (302, 304), with the understanding that these paths are merely illustrative. The driver device 102 can be applied to many other types of technical environments which utilize other kinds of rendering paths.

Rendering path 302 can process job information using Microsoft Corporation's Win32® Graphics Device Interface (GDI) functionality. In this environment, a Win32® application 314 uses Graphics Device Interface functionality 316 to express job information in a prescribed GDI graphics language. The job information can be stored in a spool storage 318 as an Enhanced Metafile (EMF). The EMF data consists of instructions which invoke GDI functions.

In a consumption phase of the rendering path 302, a print subsystem retrieves the EMF job information from the spool storage 318 and performs various operations on the job information using a print processor 320 and the rendering module A 306. The print processor 320 can perform processing relevant to one or more features of the rendering path A 302. The rendering module A 306 performs the main function of transforming the job information to a format that is expected by the target device 312 (such as PostScript or PCL). The rendering path 302 then forwards the processed job information to the target device 312 via port logic (not shown).

In the context of the Win32® application framework, the configuration module 310 can expose the properties of the rendering path 302 (and associated rendering module 306 and target device 312) using a DevCap mechanism. The configuration module 310 can propagate configuration instructions to the rendering path using a DEVMODE mechanism. The DevCap and DEVMODE functionality express configuration-related characteristics in a binary format.

On the other hand, the rendering path B 304 can process job information using, in one entirely exemplary and non-limiting case, Microsoft Corporation's WinFX functionality, in which applications can provide job information expressed in a METO-format, e.g., as described in the above-referenced U.S. patent application Ser. No. 10/836,327. In this environment, in a production phase of the path B 304, a METRO-enabled application 322 uses WinFX interface functionality 324 to express job information in the prescribed METRO format. The job information can be stored in a spool storage 326 in a METRO format. An exemplary format that can be used to store job information within the spool storage 326 is described in co-pending and commonly assigned U.S. patent application Ser. No. 10/938,476, filed Sep. 10, 2004, and U.S. patent application Ser. No. 10/949,003, filed Sep. 24, 2004, both entitled “Spooling Strategies Using Structured Job Information”; both of these applications are incorporated by reference herein in their respective entireties.

The METRO format produced by the application 322, as well as the METRO format of the job information stored in the spool file 326 expresses the job information in a hierarchal structure of nodes 328. That is, this hierarchical scheme couples the nodes together using parent-child relationships. A “top-most” node defines a so-called root node. The root node includes one or more child nodes, and the child nodes, in turn, can include one or more of their own respective child nodes, and so on. The child nodes can inherit methods, properties, metadata, etc. associated with their respective parent/ancestor nodes.

The hierarchy can be constructed according to different rules. In one exemplary and non-limiting format, the top level of the hierarchy specifies job-related information that identifies the entire job itself. The next level of the hierarchy specifies information that identifies the documents associated with the job. The next level of the hierarchy specifies information that identifies different renditions of the documents identified in the preceding level. The next level of the hierarchy specifies information that identifies different pages within the renditions of the documents identified in the proceeding level. For instance, this format can be used to express a book (corresponding to the root note) having various chapters (corresponding to document nodes). Each chapter in the book can be expressed in a prescribed form, such as black and white as opposed to color (corresponding to different rendition nodes). Each rendition includes various pages (corresponding to page nodes). The hierarchical scheme described above can be constructed using various METRO building blocks, such as various sequence parts (which couple other parts together in series relationships), selector parts (which select among different parts), fixed page parts (which express the content of document pages), and so forth. These tools also allow for the construction of job hierarchy having an arbitrary organization, e.g., not limited to the exemplary hierarchy described above.

Resource and metadata can be associated with any of the levels of the above-described hierarchy. A particular kind of metadata is a PrintTicket. A PrintTicket defines the types of processing operations that should be performed on associated parts of the hierarchy of the job information 328. In one exemplary implementation, the PrintTicket can be expressed in a markup language such as the extensible markup language (XML). In this format, print instructions can be descriptively expressed, as in the following exemplary PrintTicket excerpt:

Exemplary PrintTicket XML Excerpt

<Feature name=“PageMediaSize”>

<Option name=“NA_Letter”>
<SP name=“MediaSizeX”>

<Value>215900</Value>

</SP>
. . .
</Option>

</Feature>

This PrintTicket excerpt specifies an option “NA_Letter” assigned to a feature “PageMediaSize.” This means that, if the PrintTicket is assigned to a particular part of the hierarchical job information, then this option will apply to this part of the job information. Consider, for example, the exemplary PrintTicket 330 shown in FIG. 3. This PrintTicket 330 will apply to the node to which it is “attached,” as well as this node's child nodes (unless the child nodes include local print instructions which override the print instructions specified in the PrintTicket 330). The print instructions which apply to any node in the hierarchical job information 328 can be determined by “walking up” the hierarchy, examining and aggregating any print instructions which may apply to parent and ancestors nodes associated with the child node in question.

During a consumption phase of the path B 304, the rendering module B 308 processes the job information stored in the spool storage 326. The rendering module 308 includes one or more filter modules (332, 334, . . . 336) for performing different processing functions on the job information to generate output results. The rendering module 308 can include a filter management module 338. The filter management module 338 works in conjunction with the configuration module 310 to govern the operation of the rendering module 308. More specifically, the filter management module 338 can chain the filter modules (332, 334, . . . 336) together in different ways to achieve a desired transformation of the job information. The behavior of individual filter modules (332, 334, . . . 336) is also governed by PrintTicket information associated with parts of the job information. Namely, the filter modules (332, 334, . . . 336) interpret the PrintTicket information to determine what specific operations are to be applied to individual parts of the job information.

The precise functions performed by the filter modules (332, 334, . . . 336) are various and device-specific. In general, the job information that is processed by one or more of the filter modules (332, 334, . . . 336) retains the same format structure as the job information stored in the spool storage 326. Thus, in this exemplary implementation, the rendering module 308 does not require that the job information be converted into an intermediary form in order to process it. This, in turn, enables the rendering module 308 to processing job information in an efficient manner.

The functions performed by the individual filter modules (332, 334, . . . 336) can be generalized in the following manner. A first class of filters accepts job information in the METRO format, performs some kind of processing on this information, and then generates an output result which also conforms to this format. A second class of filter modules accepts job information which conforms to the METRO format, performs processing of this information, and then generates an output result which may not conform to the format (or which only partially conforms to the format). A third class of filter modules accepts job information which has already been converted into a non-structured format, and provides yet further modification or processing of such non-structured information.

More specifically, for example, one or more initial filter modules of the first class can be set up to modify the job information in various ways (such as by adding a watermark, etc.), but do not otherwise change the job information's basic format structure. A terminal filter module of the second class can be set up to modify the job information by changing its format, such as by either completely removing its hierarchical format or at least partially modifying its format structure. Or another upstream filter module can perform this translation, and the terminal filter module can represent a filter module of the third class, e.g., which performs some kind of post-processing on the already-transformed job information.

In any event, the one or more terminal filter modules that serve the purpose of transforming the job information into the format expected by the target device 312 serve the role of a device driver. Consider, for example, a first case in which filter module Z 336 converts the job information having the METRO format into a PDL format (e.g., PostScript, PCL, etc.) that can be fed to a printer which accepts such format. Filter module Z 336 thus serves the role of a driver. In another case, another upstream filter module can convert the job information into a printer-interpretable format; and filter module Z 336 can perform post-processing on this format. This upstream filter module in conjunction with filter module Z 336 thus serve the role of the device driver. (As a footnote, the driver can also feed job information to the target device 312 in a METRO format, providing that the target device 312 can accept this format).

In performing its tasks, the rendering module 308 may draw upon various external services 340. For example, markup services allow the rendering module 308 to parse and query the markup associated with job information content. Driver services encapsulate core rendering functionality (e.g., color tables) that can be accessed by driver functionality used in the rendering module 308. Container services provide APIs that enable reading and writing access to the job information content. Composition services allow the rendering module 308 to manipulate the job information in various ways, such as by performing decomposition, rasterization, simplification of rendering primitives, and so forth.

Moreover, in one exemplary implementation, one or more of the filter modules (332, 334, . . . 336) can be shared between the driver device 102 and the target device 312, meaning that both the driver device 102 and the target device 312 can utilize the functionality of such a filter module (or modules) in performing their prescribed tasks.

In the context of the WinFX application framework, the configuration module 310 can expose the properties of the rendering path 304 (and associated rendering module 308 and target device 312) using an XML PrintCapabilities mechanism. The following is an excerpt of exemplary information generated by this mechanism:

PrintCapabilities XML

<Feature name=“PageMediaSize”>

<Option name=“NA_Letter”>

<SP name=“MediaSizeX”>
<Value>215900</Value>

. . .
<Option name=“Legal”>
. . .

</Feature>

This excerpt exposes various features of the rendering path 304 and associated options. On the other hand, the configuration module 310 can propagate configuration instructions to the rendering path 304 using the above-described PrintTicket mechanism.

The paths (302, 304) have been described as separate entities. However, as represented by the overlapping oval 342, the paths (302, 304) can share functionality and/or interact with each other in various ways. For instance, the Win32®-GDI paths 302 can translate its output into a METRO format, upon which it can forward this information to the METRO-related path B 304. Alternatively, the METRO-related path B 304 can convert the job information into a GDI-compatible format, upon which it can forward this information to the Win32®-GDI path 302. Further, the implementation 300 can be configured so that the Win32®-GDI paths 302 can make use of the Print Capabilities and PrintTicket mechanisms to query capabilities and make configuration settings, rather than the Win32® DevCap and DEVMODE mechanisms.

A.4. Separate Application Frameworks Accessing a Single Target Device which Supports Multiple PDLs

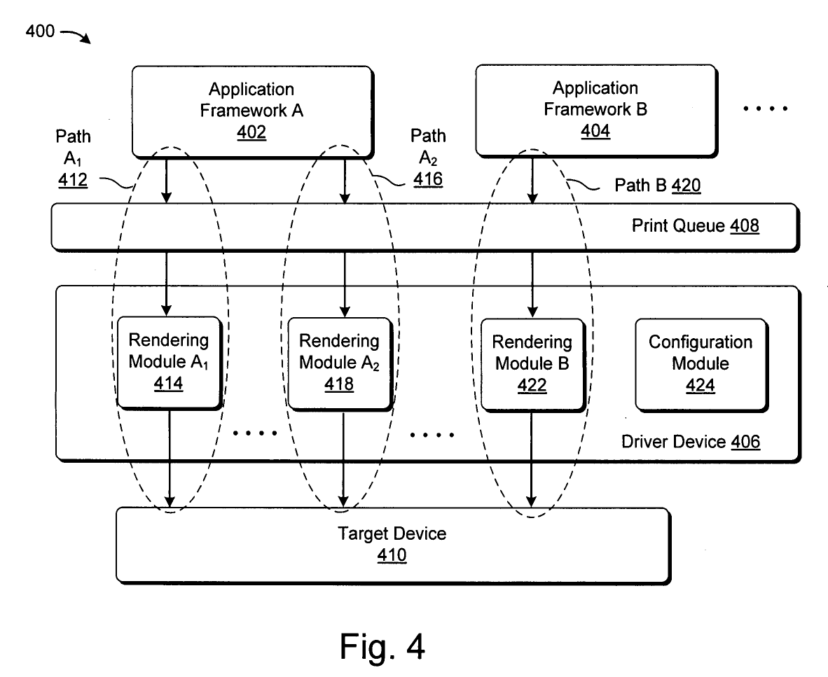

FIG. 4 shows a system 400 which is a variation of the system 100 shown in FIG. 1. FIG. 4 includes the main features of FIG. 1, including one or more application frameworks (402, 404, . . . ) which send job information to a driver device 406 via a single print queue 408. The driver device 406 processes the job information and forwards the processed job information to a target device 410. However, in the case of FIG. 4, the target device 410 can accept job information expressed in at least two different Page Description Languages (PDLs), such as PostScript, PCL, a hierarchical METRO format, and so forth.

The fact that the target device 410 can accommodate multiple PDL formats may mandate that a single application framework devote multiple rendering paths which handle these respective formats. Namely, for example, application framework A 402 includes a rendering path 412 that uses a rendering module A₁ 414 to convert the input job information into a first PDL₁ format (such as PostScript). The same application framework A 402 can devote another rendering path 416 that uses a rendering module A₂ 418 to convert the input job information into a second PDL₂ format (such as PCL). For instance, referring back to FIG. 3, one way of implementing these two paths (412, 416) is to include another print processor and associated rendering module (not shown) which feed off of the EMF data stored in the spool storage 318.

On the other hand, application framework B 404 may devote a single rendering path B 420 that uses rendering module B 422 to convert the input job information into either the first PDL₁ format or the second PDL₂ format, based on configuration information supplied to this module 422. Referring back to FIG. 3, one way of implementing this versatile path 420 is by using the configurable rendering module 308. The nature of the processing performed by the rendering module 308 can be changed based on the flexible configuration of its filter modules (332, 334, . . . 336). In another implementation, application framework B 404 can also devote plural distinct paths for handling the different PDL formats.

In any event, a single driver device 406 can encompass all of these rendering modules (414, 418, . . . 422) in a single package, and this single driver device 406 can be accessed via a single print queue 408. A configuration module 424 can govern the operation of the driver device 406 in the manner described above, except now the selection of the path depends on two degrees of freedom: the nature of the graphics layer used by the application framework; and the nature of the PDL format expected by the target device 410. In one case, the system 400 can be set up to allow the user to select the PDL format that will be used to express the processed job information. In another case, the system 400 can be pre-configured (e.g., by a system administrator) to automatically use one of the formats supported by the target device 410.

The configuration module 424 can also expose the characteristics of the different paths in the manner described above (e.g., with respect to FIG. 2). The configuration module 424 can also allow a user to set various options pertinent to the characteristics in the manner described above. In this case, though, the rendering paths will be expanded to account for the use of different PDL formats, as well as, potentially, the use of different graphics layers.

B. Exemplary Method of Operation

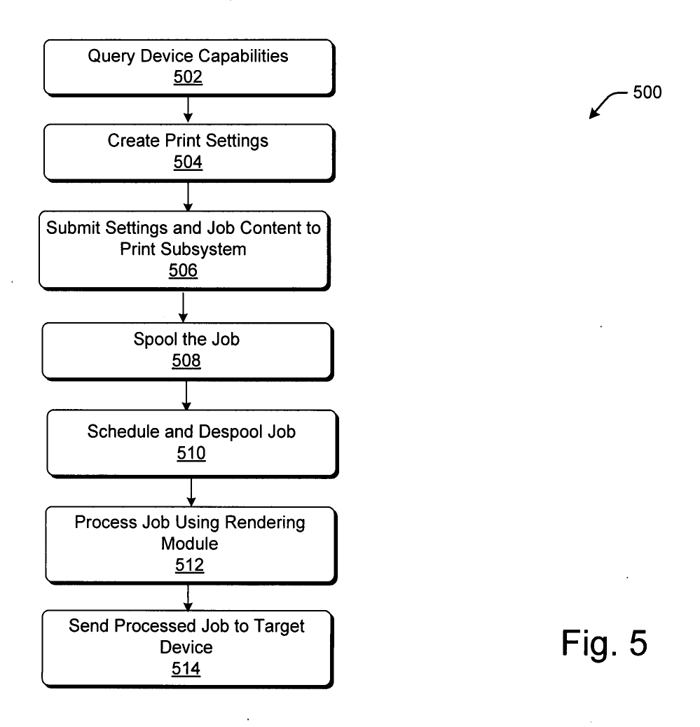

FIG. 5 describes the operation of the systems of FIGS. 1-4 in flow chart form. To facilitate discussion, certain operations are described as constituting distinct steps performed in a certain order. Such implementations are exemplary and non-limiting. Certain steps described herein can be grouped together and performed in a single operation, and certain steps can be performed in an order that differs from the order employed in the examples set forth in this disclosure.

More specifically, FIG. 5 describes a procedure 500 which sets forth the manner in which any rendering path can process job information, including, but not limited to, any of the specific rendering paths (302, 308) shown in FIG. 3, or the rendering paths (412, 416, 420) shown in FIG. 4. In explaining this procedure 500, cross-reference will be made to the components of FIG. 1.

In step 502, an application within an application framework (116, 118, . . . 120) queries the capabilities of the rendering path (112, 114, . . . ) (which amounts to querying the capabilities of the target device 110 and its associated rendering module). This step 502 may correspond to the scenario described above, where the user activates a print instruction within a particular application (e.g., a word processing program). This prompts the configuration module 146, via the print queue 108, to forward information describing the capabilities of an appropriate rendering path which couples the application to the target device 110. As shown in FIG. 2, a user interface presentation 216 may include visual indicia which demarcate common characteristics from path-specific characteristics.

In step 504, after viewing the capabilities, the user may make various selections which will govern the rendering operation. For instance, the user may make selections relevant to any number of feature options.

In step 506, the system 100 submits the job information and configuration settings to the print subsystem 106 for processing. In the exemplary and non-limiting WinFX environment described in Subsection A.3, the configuration settings can be formulated as PrintTickets which “attach” to different parts of the hierarchically expressed job information 328.

In step 508, the thus-created job information and settings are stored in a spool storage.

In step 510, representing the start of the consumption phase of the processing, the job information is retrieved from the spool storage (in a process referred to as “despooling”).

In step 512, an appropriately selected rendering module (138, 140, . . . 142) performs processing on the job information to yield processed job information. The configuration module 146 invokes one of these rendering modules (138, 140, . . . 146) depending on the nature of the transformation which should be performed. The selection of an appropriate rendering module depends, in part, on the nature of the application framework (116, 118, . . . 120) which has been used to generate the job information (which uses associated different graphics layers). The selection will also depend on the input format requirements of the target device 110.

In step 514, the processed job information is forwarded to a target device 110 via port logic (not shown).

C. Exemplary Computer Environment

In one exemplary implementation, certain aspects of the systems of FIGS. 1-4 can be implemented as computer code executed by one or more computer devices. For example, as mentioned, the applications and print subsystem shown in FIG. 1 can be implemented, at least in part, as software providing by one or more computer devices. In this case, FIG. 6 provides information regarding an exemplary computer environment 600 that can be used to implement any aspect of the applications and print subsystem shown in FIG. 1.

The computing environment 600 includes a general purpose or sever type computer 602 and a display device 604. However, the computing environment 600 can include other kinds of computing equipment. For example, although not shown, the computer environment 600 can include hand-held or laptop devices, set top boxes, game consoles, mainframe computers, etc. Further, FIG. 6 shows elements of the computer environment 600 grouped together to facilitate discussion. However, the computing environment 600 can employ a distributed processing configuration. In a distributed computing environment, computing resources can be physically dispersed throughout the environment.

Exemplary computer 602 includes one or more processors or processing units 606, a system memory 608, and a bus 610. The bus 610 connects various system components together. For instance, the bus 610 connects the processor 606 to the system memory 608. The bus 610 can be implemented using any kind of bus structure or combination of bus structures, including a memory bus or memory controller, a peripheral bus, an accelerated graphics port, and a processor or local bus using any of a variety of bus architectures.

Computer 602 can also include a variety of computer readable media, including a variety of types of volatile and non-volatile media, each of which can be removable or non-removable. For example, system memory 608 includes computer readable media in the form of volatile memory, such as random access memory (RAM) 612, and non-volatile memory, such as read only memory (ROM) 614. ROM 614 includes an input/output system (BIOS) 616 that contains the basic routines that help to transfer information between elements within computer 602, such as during start-up. RAM 612 typically contains data and/or program modules in a form that can be quickly accessed by processing unit 606.

Other kinds of computer storage media include a hard disk drive 618 for reading from and writing to a non-removable, non-volatile magnetic media, a magnetic disk drive 620 for reading from and writing to a removable, non-volatile magnetic disk 622 (e.g., a “floppy disk”), and an optical disk drive 624 for reading from and/or writing to a removable, non-volatile optical disk 626 such as a CD-ROM, DVD-ROM, or other optical media. The hard disk drive 618, magnetic disk drive 620, and optical disk drive 624 are each connected to the system bus 610 by one or more data media interfaces 628. Alternatively, the hard disk drive 618, magnetic disk drive 620, and optical disk drive 624 can be connected to the system bus 610 by a SCSI interface (not shown), or other coupling mechanism. Although not shown, the computer 602 can include other types of computer readable media, such as magnetic cassettes or other magnetic storage devices, flash memory cards, CD-ROM, digital versatile disks (DVD) or other optical storage, electrically erasable programmable read-only memory (EEPROM), etc.

Generally, the above-identified computer readable media provide non-volatile storage of computer readable instructions, data structures, program modules, and other data for use by computer 602. For instance, the readable media can store the operating system 630, application-specific functionality 634, other program modules 634, and program data 636. Any of this media can implement any aspect of the system 100 shown in FIG. 1, including the print subsystem 106 (and its driver device 102).

The computer environment 600 can include a variety of input devices. For instance, the computer environment 600 includes the keyboard 638 and a pointing device 1640 (e.g., a “mouse”) for entering commands and information into computer 602. The computer environment 600 can include other input devices (not illustrated), such as a microphone, joystick, game pad, satellite dish, serial port, scanner, card reading devices, digital or video camera, etc. Input/output interfaces 642 couple the input devices to the processing unit 606. More generally, input devices can be coupled to the computer 602 through any kind of interface and bus structures, such as a parallel port, serial port, game port, universal serial bus (USB) port, etc.

The computer environment 600 also includes the display device 604. A video adapter 644 couples the display device 604 to the bus 610. In addition to the display device 604, the computer environment 600 can include other output peripheral devices, such as printers, facsimile machines, etc. Any of these devices can receive the processed job information produced by the driver device 102.

Computer 602 operates in a networked environment using logical connections to one or more remote computers, such as a remote computing device 646. The remote computing device 646 can comprise any kind of computer equipment, including a general purpose personal computer, portable computer, a server, etc. Remote computing device 646 can include all of the features discussed above with respect to computer 602, or some subset thereof. Or the remote device 646 can represent any kind of target device (110) described above.

Any type of network 648 can be used to couple the computer 602 with remote computing device 646, a LAN, etc. The computer 602 couples to the network 648 via network interface 650, which can utilize broadband connectivity, modem connectivity, DSL connectivity, or other connection strategy. Although not illustrated, the computing environment 600 can provide wireless communication functionality for connecting computer 602 with remote computing device 646 (e.g., via modulated radio signals, modulated infrared signals, etc.).

In closing, a number of examples were presented in this disclosure in the alternative (e.g., case A or case B). In addition, this disclosure encompasses those cases which combine alternatives in a single implementation (e.g., case A and case B), even though this disclosure may not have expressly mention these conjunctive cases in every instance.

Moreover, a number of features were described herein by first identifying exemplary problems that these features can address. This manner of explication does not constitute an admission that others have appreciated and/or articulated the problems in the manner specified herein. Appreciation and articulation of the problems present in the job information processing arts are to be understood as part of the present invention. More specifically, there is no admission herein that the features described in the Background section of this disclosure constitute prior art.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A system for processing job information, comprising:
at least one application framework for at least preparing job information expressed in a prescribed graphics language;
a rendering subsystem for processing the job information using plural selectable rendering paths;
wherein the rendering subsystem includes an integrated driver device which comprises:
a rendering queue for coupling said at least one application framework with the rendering subsystem for all of the plural selectable rendering paths,
plural selectable rendering modules for performing different respective processing operations on the job information in the context of the respective plural rendering paths; and
a configuration module for coordinating the processing of the job information using a selected one of the plural rendering modules in the context of a selected one of the plural rendering paths, to yield processed job information,
wherein the processed job information is forwarded by the driver device to a target device.

2. An integrated driver device for processing job information, comprising:
plural selectable rendering modules for performing different respective processing operations on the job information in the context of respective plural selectable rendering paths; and
a configuration module for coordinating the processing of the job information using a selected one of the plural rendering modules in the context of a selected one of the plural rendering paths, to yield processed job information,
wherein the processed job information is forwarded by said selected one of the plural rendering modules to a target device.

3. The driver device of claim 2, wherein the driver device is configured to interact with at least one application framework via a single access interface with respect to all of the plural selectable rendering paths.

4. The driver device of claim 3, wherein the single access interface is a single rendering queue.

5. The driver device of claim 2, wherein the driver device is configured to interact with plural application frameworks that use plural respective graphics languages to express the job information.

6. The driver device of claim 5, wherein the configuration module is configured to select said selected one of the plural rendering modules based on a graphics language used by an application framework that is used to prepare the job information.

7. The driver device of claim 2, wherein the configuration module is configured to select said selected one of the plural rendering modules based on a format used by the target device to accept the processed job information.

8. The driver device of claim 2, wherein the configuration module is configured to expose the characteristics of said selected one of the plural rendering paths.

9. The driver device of claim 8, wherein the exposed characteristics comprise:
a first set of characteristics which are unique to said selected one of the plural rendering paths; and
a second set of characteristics which are shared by said selected one of the plural rendering paths and at least one other rendering path.

10. The driver device of claim 8, wherein the configuration module is further configured use the exposed characteristics to define configuration settings which govern the operation of said selected one of the plural rendering modules.

11. The driver device of claim 2, wherein at least one of the rendering modules includes at least one filtering module, wherein the filtering module is shared between the driver device and the target device.

12. One or more machine-readable media for storing machine-readable instructions for implementing the driver device of claim 2.

13. A method for rendering job information to a target device, comprising:
receiving job information from an application framework via a single access interface;
automatically selecting a rendering path to process the job information from among a plurality of available rendering paths, to define a selected rendering path having associated characteristics;
processing the job information using the selected rendering path based on the associated characteristics, to yield processed job information; and
outputting the processed job information to a target device.

14. The method of claim 13, wherein the single access interface is a single rendering queue.

15. The method of claim 13, wherein the selection of the selected rendering path is based on a consideration of a graphics language used by the application framework.

16. The method of claim 13, wherein the selection of the selected rendering path is based on a consideration of one or more of the following factors:
(a) a format used by the target device to accept the processed job information;
(b) a determination of what rendering path is best suited to archive the job information or to package the job information; or
(c) a determination of what rendering path is best suited to compress the job information.

17. The method of claim 13, further comprising exposing the characteristics of the selected rendering path.

18. The method of claim 17, wherein the exposed characteristics comprise:
a first set of characteristics which are unique to the selected rendering path; and
a second set of characteristics which are shared by the selected rendering path and at least one other rendering path.

19. The method of claim 17, further comprising using the exposed characteristics to define configuration settings which govern the operation of the selected rendering path.

20. One or more machine-readable media for storing machine-readable instructions for implementing the method of claim 13.
